(19) United States
(12) Patent Application Publication
(10) Pub. No.: US 2011/0095674 A1
(43) Pub. Date: Apr. 28, 2011

(54) Cold Cathode Lighting Device As Fluorescent Tube Replacement

(76) Inventors: Richard N. Herring, Longmont, CO (US); Andras Kuthi, Thousand Oaks, CA (US)

(21) Appl. No.: 12/766,440

(22) Filed: Apr. 23, 2010

Related U.S. Application Data
(60) Provisional application No. 61/255,180, filed on Oct. 27, 2009.

(51) Int. Cl. H01J 1/62; H01J 9/18

(52) U.S. Cl. 313/496; 445/33; 445/31

(57) ABSTRACT

A cold cathode lighting device is a fluorescent tube replacement and has a transparent tube, a cold cathode formed as a wire or rod with an electron emissive surface and passing through a center of the transparent tube. An extraction grid is formed around and spaced apart from the cold cathode and has an external diameter smaller than an inner diameter of the transparent tube. A phosphor material and a conductive material form an anode on an inner surface of the transparent tube. A vacuum is maintained within the transparent tube and a power conversion circuit in an end unit converts electrical power into a first potential applied to the cold cathode, a second potential applied to the extraction grid and a third potential applied to the anode. Electrons emitted from the cold cathode accelerate towards the anode and light is emitted from the fluorescent tube replacement light emitting device.

### RELATED APPLICATIONS

This application claims priority to U.S. Patent Application Ser. No. 61/255,180, filed Oct. 27, 2009, and is incorporated herein by reference.

### BACKGROUND

FIG. 1 shows one exemplary fluorescent lighting fixture 100 of the prior art. In lighting fixture 100, a fluorescent tube 102 is supported at each end by a support 108A and 108B that also provides electrical connectivity from a power source 112 to tube 102. Fixture 100 also includes a starter device 106 that preheats and ‘strikes’ an arc within tube 102 to start light emission, and a ballast 104 that steps up voltage to and controls current through tube 102 once the arc is struck, since tube 102 has negative resistivity.

Once the arc is struck within tube 102, electrons collide with atoms of a gas, typically mercury vapor, enclosed within a tube and energy is transferred to the atoms, causing the atom's outer electron to jump to a higher energy level. As the atoms' electrons revert to their more stable lower energy state, photons are emitted mainly at wavelengths in the ultraviolet (UV) region of the spectrum (predominantly at wavelengths of 253.7 nm and 185 nm), and are not visible to the human eye. These photons are absorbed by a fluorescent material coated on the inside of tube 102 and re-emitted at a wavelength visible to the human eye.

When the lamp is turned on, the starter device 106 causes the electric to heat cathodes 110A and 110B such that electrons are emitted. These electrons collide with and ionize noble gas atoms in tube 102 surrounding the cathode to form a plasma by a process of impact ionization. As a result of avalanche ionization, the conductivity of the ionized gas rapidly rises, allowing higher currents to flow through the lamp as the arc is struck. The ballast 104 then limits current through tube 102 to prevent overheating.

FIG. 2 shows one exemplary cold cathode lighting unit 200 of the prior art, including a cold cathode light emitting tube 202 and an inverter 204. Electrodes 210A and 210B are located at opposite ends of tube 202 and inverter 204 and/or transformer generates high voltage alternating current (AC) electricity that is applied across electrodes 210. A neon sign is an example of cold cathode lighting unit 200.

In many lighting units, electrodes 210 alternate between anode and cathode operation because the applied electricity is alternating current, and ionization of a gas (e.g., neon or mercury vapor) followed by return of atoms to their resting state within tube 202 generates light.

### SUMMARY

In an embodiment, a cold cathode lighting device is a fluorescent tube replacement. The lighting device has a transparent tube, a cold cathode formed as a wire or rod with an electron emissive surface and passing through a center of the transparent tube. An extraction grid is formed around and spaced apart from the cold cathode and has an external diameter smaller than an inner diameter of the transparent tube. An anode is formed on an inner surface of the transparent tube and includes a phosphor material and a conductive material. A first end unit has a first power conversion circuit potted within a dielectric material. The first power conversion circuit has electrical connections to each of the cold cathode, the extraction grid and the anode. A vacuum is maintained within the transparent tube and the first power converter converts electrical power applied to the device into a first potential applied to the cold cathode, a second potential applied to the extraction grid and a third potential applied to the anode. Electrons are emitted from the cold cathode are accelerated towards the anode and light is emitted from the fluorescent tube replacement light emitting device.

In another embodiment, a method fabricates a light emitting device. A transparent tube is formed and an anode is applied to the interior of the transparent tube. A first end unit is formed to include a first power converter circuit potted in a dielectric material, a first tube end with an evacuation tube and first feed-through pins. A second end unit if formed from dielectric material to include a second tube end with second feed-through pins. A cold cathode with an emissive surface is formed from one of (a) a conductive wire, (b) a conductive rod, (c) a conductive tube, (d) a non-conductive rod coated with a conductive material, and (e) a non-conductive tube coated with a conductive material. A substantially cylindrical extraction grid is formed with an internal diameter greater than the external diameter of the cold cathode. The cold cathode is inserted into the center of the extraction grid. The first end unit is electrically and mechanically attached to a first end of the cold cathode and extraction grid assembly. The second end unit is mechanically attached to a second end of the cold cathode and extraction grid assembly. The first and second end units, the cold cathode, the extraction grid assembly are inserted into the transparent tube, the first tube end is attached to a first end of the transparent tube, and the second tube end is attached to the other end of the transparent tube. The transparent tube is evacuated and sealed, and first and second end caps are applied to the first and second ends of the transparent tube.

In another embodiment, a method fabricates a light emitting device to replace a fluorescent tube. A transparent tube is formed and an anode is applied to the interior of the transparent tube. A first end unit is formed to include a first tube end with an evacuation tube and first feed-through pins. A second end unit is formed from dielectric material to include a second tube end with second feed-through pins. A cold cathode with an emissive surface is formed from one of (a) a conductive wire, (b) a conductive rod, (c) a conductive tube, (d) a non-conductive rod coated with a conductive material, and (e) a non-conductive tube coated with a conductive material. A substantially cylindrical extraction grid is formed with an internal diameter greater than the external diameter of the cold cathode. The cold cathode is inserted into the center of the extraction grid. The first end unit is mechanically and electrically attached to a first end of the cold cathode and extraction grid assembly. The second end unit is mechanically attached to a second end of the cold cathode and extraction grid assembly. The first and second ends and the cold cathode and the extraction grid assembly are inserted into the transparent tube. The first tube end is attached to a first end of the transparent tube and the second tube end is attached to the other end of the transparent tube. The transparent tube is evacuated and sealed. A first power converter circuit is potted in a dielectric material and electrically connected to the anode, cold cathode and extraction grid via the first feed through pins. Electrical pins of the first power converter circuit connect to a power source and mechanically support the first power converter circuit and transparent tube. A first end cap is applied to first power converter and a second end cap is applied to the second end of the transparent tube.

In another embodiment, a cold cathode light emitting device includes a transparent tube and a cold cathode with a substantially cylindrical electron emissive surface that passes through a center of the transparent tube. A spacing fiber is wound around the cold cathode at a first pitch and in a first direction. A conducting fiber wound around the cold cathode and the spacing fiber at a second pitch and opposite to the first direction, such that the conducting fiber is spaced apart from the cold cathode by the spacing fiber. An anode is formed on an inner surface of the transparent tube and includes a phosphor material and a conductive material. A first end unit includes a first power conversion circuit potted within a dielectric material. The first power conversion circuit has electrical connections to each of the cold cathode, the conducting fiber and the anode. A vacuum is maintained within the transparent tube and the first power converter converts electrical power applied to the device into a first potential applied to the cold cathode, a second potential applied to the conducting fiber and a third potential applied to the anode. Electrons are emitted from the cold cathode and accelerated towards the anode such that light is emitted from the fluorescent tube replacement light emitting device.

In another embodiment, a method fabricates a light emitting device to replace a fluorescent tube. A transparent tube is formed and an anode is applied to the interior of the transparent tube. A first end unit is formed to include a first power converter circuit potted in a dielectric material, a first tube end with an evacuation tube and first feed-through pins. A second end unit is formed from dielectric material to include a second tube end with second feed-through pins. A cold cathode with an emissive surface is formed from one of (a) a conductive wire, (b) a conductive rod, (c) a conductive tube, (d) a non-conductive rod coated with a conductive material, and (e) a non-conductive tube coated with a conductive material. A spacer fiber is wound around the cold cathode at a first pitch and in a first direction. A conducting fiber is wound around the spacer fiber and the cold cathode at a second pitch and in the opposite direction to the first direction to form a cold cathode and extractor assembly. The first end unit is mechanically and electrically attached to a first end of the cold cathode and extractor assembly. The second end unit is mechanically attached to a second end of the cold cathode and conducting fiber assembly. The first and second ends, the cold cathode and the conducting fiber assembly are inserted into the transparent tube. The first tube end is attached to a first end of the transparent tube and the second tube end is attached to the other end of the transparent tube. The transparent tube is evacuated, filled with an inert gas at low pressure, and sealed. First and second end caps are applied to the first and second ends of the transparent tube.

In another embodiment, a cold cathode light emitting device has a transparent tube, an insulator tube passing through a center of the transparent tube. The insulator tube has a plurality of trenches formed lengthwise on the outer surface of the tube, has an emissive conductive material formed at the bottom of each of the trenches, and has an extractor conductor formed on the outer surface of the tube between the trenches. An anode is formed on an inner surface of the transparent tube and includes a phosphor material and a conductive material. A first end unit has a first power conversion circuit potted within a dielectric material. The first power conversion circuit has electrical connections to each of the emissive conductive material, the extractor conductor and the anode. A vacuum is maintained within the transparent tube and the first power converter converts electrical power applied to the device into a first potential applied to the emissive conductor, a second potential applied to the extractor conductor and a third potential applied to the anode. Electrons emitted from the emissive conductor are accelerated towards the anode and light is emitted from the fluorescent tube replacement light emitting device.

In another embodiment, a light emitting device has a transparent tube, a first anode passing through the center of the transparent tube, a cylindrical mesh passing through the center of the transparent tube and surrounding the first anode, a second anode formed on an inner surface of the transparent tube has a phosphor material and a conductive material, and a first end unit with a first power conversion circuit potted within a dielectric material. The first power conversion circuit has electrical connections to each of the emissive conductive material, the extractor conductor and the anode. A gas at a low pressure is maintained within the transparent tube and the first power converter converts electrical power applied to the device into a first potential applied to the first anode, a second potential applied to the cylindrical mesh, and a third potential applied to the second anode. Plasma is formed in a first gap between the first anode and the cylindrical mesh but not in a second gap between the cylindrical mesh and the second anode. Free electrons of the plasma are emitted from the cylindrical mesh and accelerated towards the second anode such that light is emitted from the light emitting device.

### BRIEF DESCRIPTION OF THE FIGURES

FIG. 1 shows one fluorescent lighting unit of the prior art.

FIG. 2 shows one cold cathode lighting unit of the prior art.

FIG. 3 shows one exemplary cold cathode lighting device as a fluorescent tube replacement, in an embodiment.

FIG. 4 shows the cold cathode lighting device of FIG. 3 in further detail.

FIG. 5 shows an exemplary cross section A-A through the cold cathode lighting device of FIGS. 3 and 4, illustrating the spatial relationship between the cold cathode, the extraction grid and the anode, in an embodiment.

FIG. 6 shows an exemplary cross section A-A through the cold cathode lighting device of FIGS. 3 and 4, illustrating an alternate configuration of the extraction grid, in an embodiment.

FIG. 7 shows an exemplary cross section A-A through the cold cathode lighting device of FIGS. 3 and 4, illustrating yet another alternate configuration of the extraction grid, in an embodiment.

FIG. 8A shows an exploded view of a first exemplary end of the cold cathode lighting device of FIGS. 3 and 4.

FIG. 8B shows an exploded view of a second exemplary end of the cold cathode lighting device of FIGS. 3 and 4 that is similar to the first exemplary end of FIG. 8A, in an embodiment.

FIG. 8C shows an exploded view of a second exemplary end of the cold cathode lighting device of FIGS. 3 and 4 that provides mechanical support for the cold cathode and the extraction grid, in an embodiment.

FIGS. 9, 10 and 11 illustrate exemplary use of spacers for maintaining position of the cold cathode and the extraction grid within the transparent tube of FIGS. 3 and 4.

FIG. 12 is a flowchart illustrating one exemplary process for constructing the cold cathode lighting device of FIGS. 3 and 4, in an embodiment.

FIG. 13 shows one end of an exemplary cold cathode light emitting device similar to the device of FIGS. 3 and 4, but with an end unit positioned external to the transparent tube, in an alternate embodiment.

FIG. 14 shows one exemplary cold cathode lighting device configured with an Edison thread attachment that allows the device to be used within a conventional Edison screw lighting fixture, in an embodiment.

FIG. 15 shows one exemplary cold cathode lighting device configured to operate within an unmodified fluorescent tube lighting fixture.

FIG. 16 shows exemplary constructing the cold cathode and extractor assembly for use in the cold cathode lighting device of FIG. 4, in an alternate embodiment.

FIG. 17 shows a cross section through the cold cathode and extraction grid of FIG. 16.

FIG. 18 is a cross section showing an alternate construction of a cold cathode emissive surface and an extraction conductor formed on an insulator tube and for use in a cold cathode lighting device, in an embodiment.

FIG. 19 is a cross section showing a portion of the insulator tube of FIG. 18.

FIG. 20 shows the portion of FIG. 19 with the cold cathode emissive surface and the extraction conductor added.

FIG. 21 shows an alternate lamp embodiment wherein plasma is formed between a cathode wire and a containment grid.

FIG. 22 is a cross section through the lamp of FIG. 21.

FIG. 23 shows one exemplary method for fabricating a cold cathode fluorescent tube replacement lighting device utilizing the cold cathode and extractor assembly of FIGS. 16 and 17, in an embodiment.

FIG. 24 is a flowchart illustrating one exemplary method for manufacturing the cold cathode and extractor assembly of FIGS. 18, 19 and 20, in an embodiment.

### DETAILED DESCRIPTION OF THE EMBODIMENTS

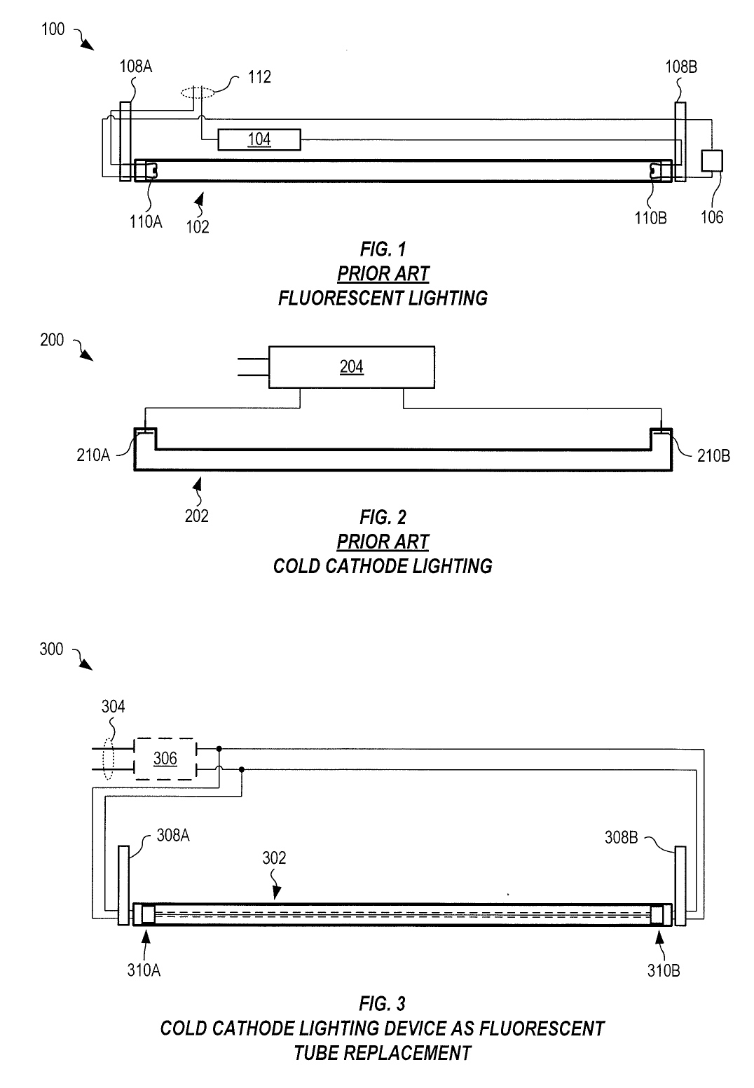

FIG. 3 shows one exemplary cold cathode lighting device 302 as a fluorescent tube replacement. Device 302 is shown mounted between supports 308A and 308B of a lighting system 300. Supports 308A and 308B may represent supports 108A and 108B of prior art lighting fixture 100, FIG. 1. That is, device 302 may be utilized within an existing fluorescent lighting fixture, when ballast 104 and starter 106 are removed from the electrical circuit.

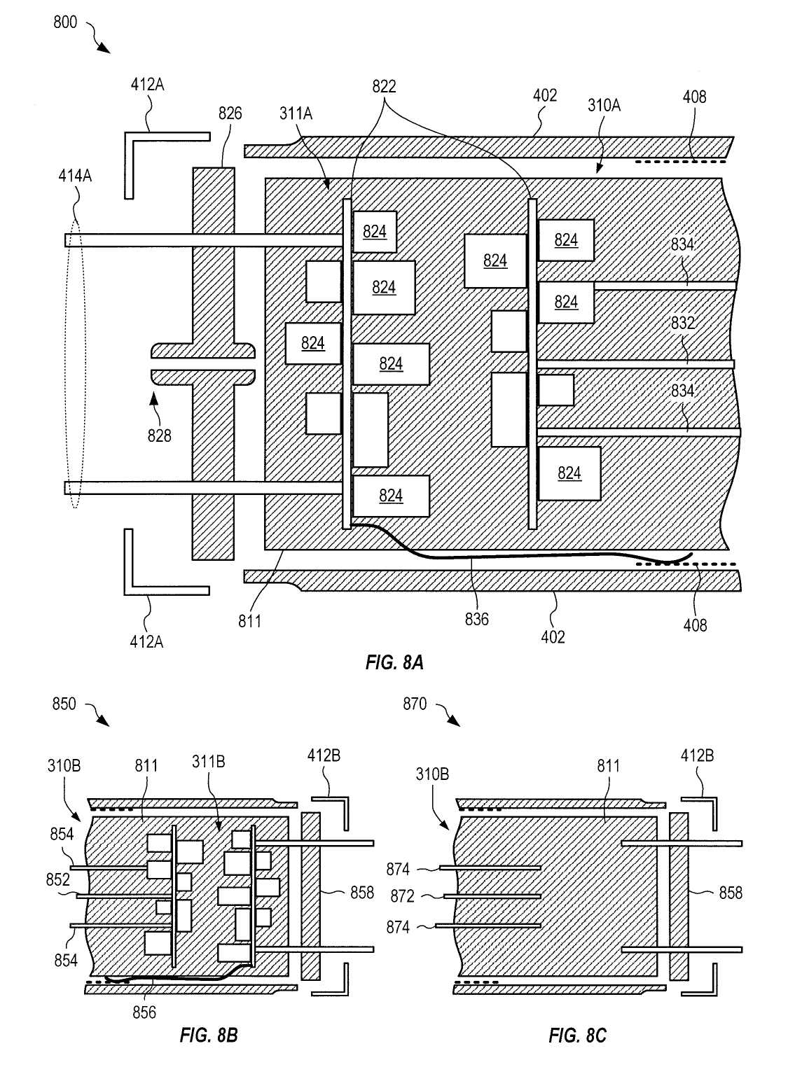

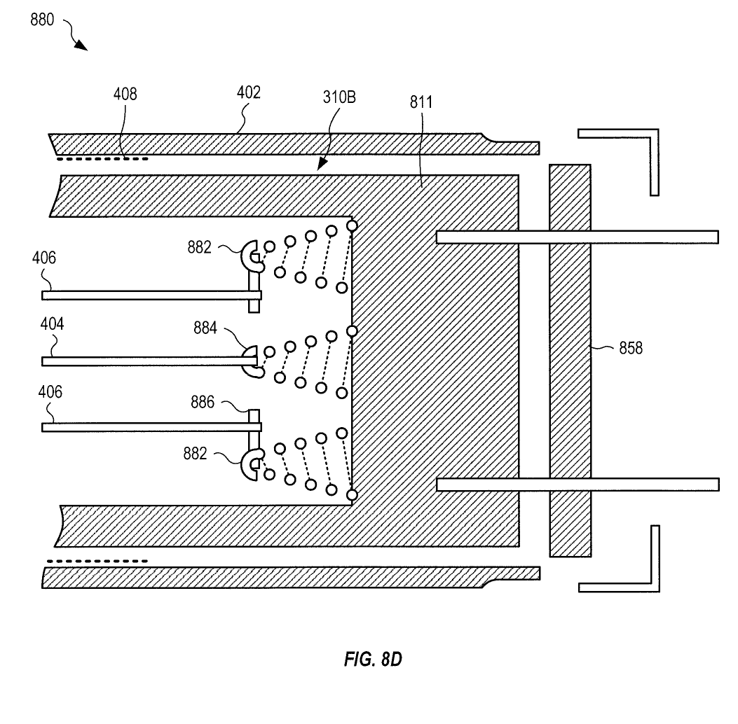

Each end of device 302 is shown with an end unit 310A and 310B that may include a power converter (e.g., power converters 311A and 311B of FIG. 4) that connects to power supply 304. Power supply 304 may represent power supply 112 of FIG. 1, such as a domestic or industrial AC power supply of 110-240V at 50-60 Hz. Device 302 may have alternate configurations, as shown in FIGS. 8C, 8D, 13, 14 and 15 and described below.

Lighting system 300 is also shown with an optional dimming unit 306 that may represent a conventional light dimming unit as used with incandescent lighting, wherein operation of dimmer 306 controls light output by device 302.

FIG. 4 shows cold cathode lighting device 302 of FIG. 3 in further detail. A cold cathode element 404 and an extraction grid 406 combine to form a cold cathode and extractor assembly 416. Device 302 has a transparent tube 402 that has an anode 408 formed on an inside surface of the tube, cold cathode and extractor assembly 416, two end units 310 with at least one power converter 311, end caps 412A and electrical connection and mechanical support pins 414. Device 302 has a length L that is selected to match the length of standard fluorescent lighting tubes (e.g., 2 feet, 4 feet or 8 feet), and has a diameter D that is substantially one inch, similar to the diameter of many standard fluorescent lighting tubes. Transparent tube 402 is transparent or translucent to visible light and may be made of one or more of glass, quartz and plastic. For simplicity, the term transparent tube in this document shall include tubes that are transparent, translucent, or both.

Electrical and mechanical support pins 414A and 414B, located at opposite ends of device 302, provide electrical connection from a power source (e.g., power supply 304, FIG. 3) to power converters 311 and mechanical support for device 302, such that device 302 is supported and powered within and from a fluorescent lighting fixture (e.g., fixture 100, FIG. 1). Within fixture 100, device 302 replaces fluorescent tube 102, and ballast 104 and starter 106 are electrically disconnected and may optionally be removed from fixture 100.

End units 310A and 310B are substantially cylindrical in shape and fit within either end of tube 402, as shown in FIG. 4, and provide mechanical support for cold cathode 404 and extraction grid 406. At least one end unit 310 includes power converter 311 configured with a plurality of electronic components for converting electrical power received at pins 414 into power for cold cathode 404, extraction grid 406 and anode 408. See FIG. 8A for further exemplary detail on power converter 311A. These electrical components may be formed as one or more circuits (e.g., formed on one or more circuit boards or flex circuits) and are potted to form end units 310.

Cold cathode 404 may be formed as a wire or rod and may have an enhanced electron emissive surface applied thereto. That is, the surface of cold cathode 404 may be etched, coated, sputtered or otherwise formed to enhance electron emission. Cold cathode 404 may have a diameter between 0.5 mm and 5 mm. Cold cathode 404 may be formed of metal or other electrically conductive material. Cold cathode 404 may be tubular without departing from the scope hereof. In an alternate embodiment, cold cathode is formed of a non-conductive material that is coated with a conductive electron emissive surface.

A voltage between −6 KV to −16 KV relative to an anode, such as anode 408, is applied to cold cathode 404 by one or both of power converters 311. Cold cathode 404 has an emitted cathode current of between 1-10 mA. Cold cathode 404 may be made of a material that facilitates formation of an electron emissive surface.

Extraction grid 406 is formed as a perforated cylindrical shape that provides a radial distance R from cold cathode 404, where R is in the range of 1 to 10 mm. A voltage in a range between 500 volts and 5000 volts is applied to extraction grid 406 by one or both of power converters 311. Since the voltage of extraction grid 406 is substantially more positive than the voltage applied to cold cathode 404, electrons are extracted from cold cathode 404 and accelerated towards and through extraction grid 406.

Anode 408 may be formed of one or more electrically conductive layers, including a phosphor layer that emits light when impacted by electrons generated by cold cathode 404. The phosphor material may be similar to phosphors used in field emission displays (FEDs). Anode 408 may be deposited by one or more of spray, slurry settlement or electrophoretic deposition (EPD). A lacquer may be applied to the anode to stabilize the phosphor layer within the cold cathode lighting device before applying an electrically conductive layer. Anode 408 is preferably at a ground potential, and is held at a voltage relatively positive to the voltage applied to extraction grid 406 and cold cathode 404. Electrons emitted from cold cathode 404 are accelerated towards and through extraction grid 406 and are further accelerated towards anode 408 where they impact the phosphor layer of anode 408, stimulating light emission by the phosphor layer of the anode. In an embodiment, the field strength as expressed in volts per millimeter between cold cathode 404 and extraction grid 406 is greater than the field strength between extraction grid 406 and anode 408.

In one embodiment, anode 408 is formed of a phosphor layer applied over a transparent and conductive Indium tin dioxide layer (or other conductive layer) formed on the inside of tube 402. In another embodiment, anode 408 is formed of a phosphor layer applied to the inside of tube 402 with a thin aluminum layer applied over the phosphor layer, wherein electrons penetrate the aluminum layer to excite the phosphor layer. In this embodiment, the aluminum layer also functions as a mirror to reflect light generated by the phosphor layer out of device 302. The aluminum layer may have a thickness in the range 400 to 900 nanometers.

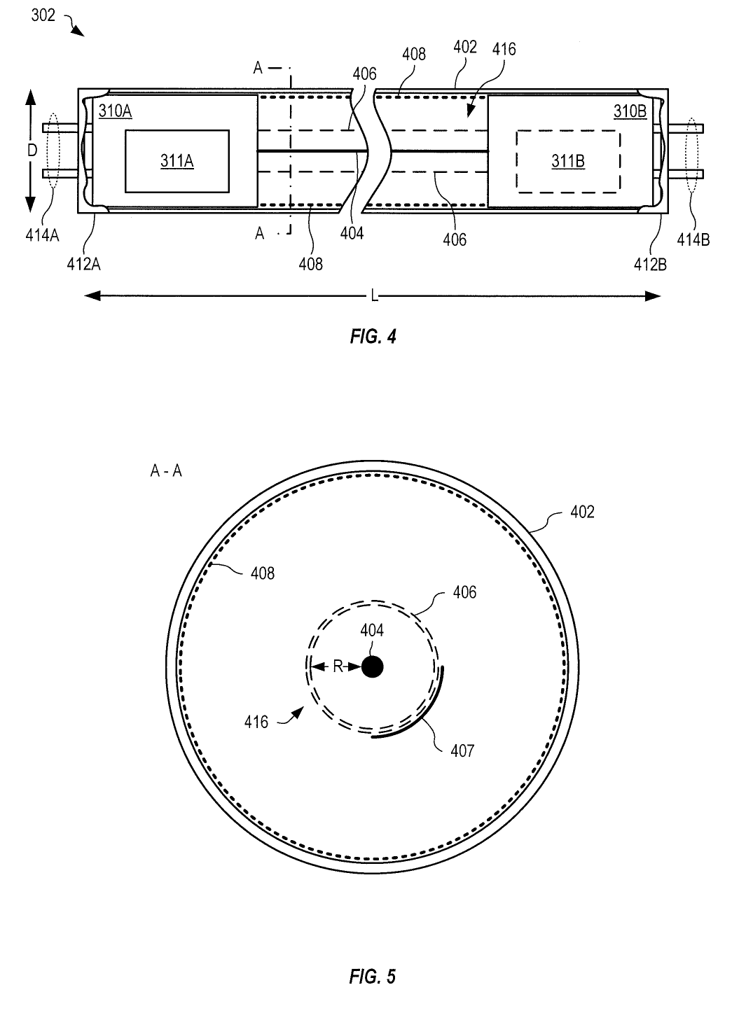

FIG. 5 shows a cross section A-A through cold cathode lighting device 302 of FIGS. 3 and 4, illustrating extraction grid 404 formed as a mesh. In particular, extraction grid 406 is formed from an electrically conductive mesh that wraps around cold cathode 404 to form a cylinder at a distance R from cold cathode 404 to form cold cathode and extractor assembly 416. Optionally, a getter material 407 is applied to at least part of anode 408. In another embodiment, getter material 407 is applied to at least part of an outer surface of extraction grid 406. In an embodiment, a conventional getter is included within tube 402 and connects to external pins to allow conventional flashing techniques to be used.

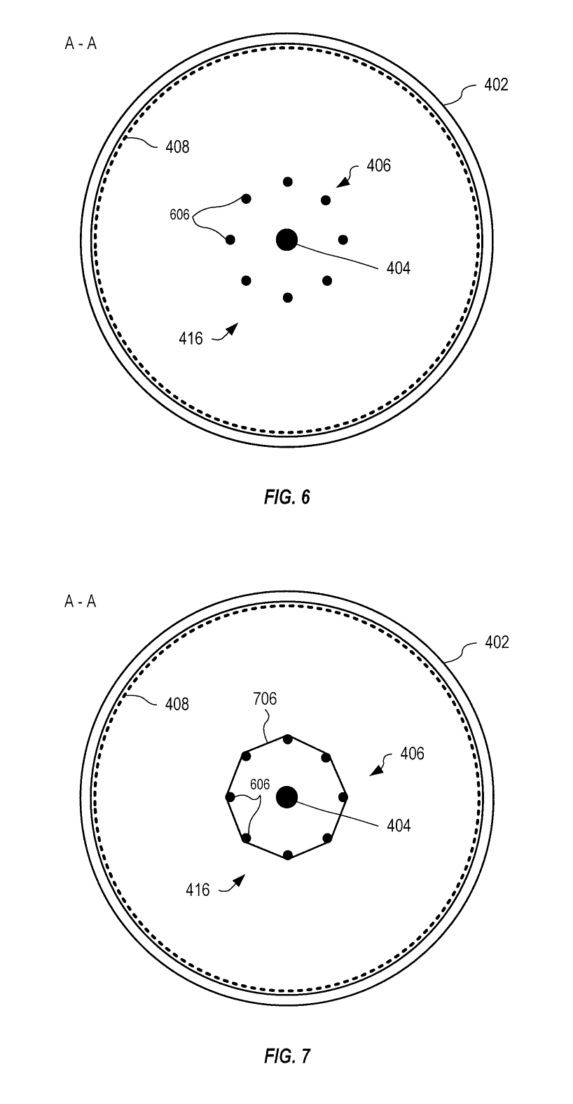

FIG. 6 shows a cross section A-A through cold cathode lighting device 302 of FIGS. 3 and 4, in an alternate embodiment, where extraction grid 406 is formed by positioning a plurality of equally spaced electrically conductive wires (or rods) 606 substantially parallel to, and spaced a distance R from, cold cathode 404, to form cold cathode and extractor assembly 416.

FIG. 7 shows the embodiment of FIG. 6 with the addition of a conductive wire 706 wrapped helically around the outside of wires 606 for the entire length of cold cathode 404 to form extraction grid 406, and thereby cold cathode and extractor assembly 416. In this embodiment, wires 606 may be formed of insulating material because they serve as supports for the conductive wire that function as the extraction grid; alternatively wires 606 may be of conductive material. In an embodiment, conductive wire 706 is mechanically attached to wires 606 by one or more of techniques included within the group of: crimping, soldering, laser welding, and so on.

FIG. 8A shows an exploded view of a first exemplary end 800 of cold cathode lighting device 302 of FIG. 3. In one example of construction, a tube end 826 has pins 414A feeding through, as shown in FIG. 8A. Tube end 826 is also formed with an evacuation tube 828 that is used to evacuate and seal tube 402 once both ends are attached to tube 402. At least one circuit board 822, with attached components 824, is connected to pins 414A and the circuitry is potted in a dielectric material 811 to form end unit 310A. End unit 310A may include connectors 832, 834 and 836 that provide electrical connectivity (and optionally mechanical support) to cold cathode 404, extraction grid 406 and electrical connectivity to anode 408, respectively, from power converter 311A. In an alternate embodiment, circuit boards 822 connect directly to cold cathode 404 and extraction grid 406 such that ends of cold cathode 404 and extraction grid 406 are also potted within dielectric material 811 of end unit 310A. Circuit board 822 may also be constructed as a flex circuit that is shaped (e.g., curled) to fit within tube 402.

More than one of connector 836 may be radially positioned around end unit 310A and sprung to provide contact to anode 408, and optionally mechanical support for end unit 310A, once end unit 310A is positioned within tube 402, as shown. Connectors 832 and 834 may attach directly to cold cathode 404 and extraction grid 406 or may attach with one or more springs to provide tension to cold cathode 404 and extraction grid 406, respectively, and as shown in further detail below. Once tube end 826 is attached to tube 402, and a vacuum is formed within device 302 by evacuating air through evacuation tube 828, evacuation tube 828 is sealed (e.g., by heated pinch) and end cap 412A is applied (e.g., using a potting type material). The other end of device 302 may be similar to end 800, or may exclude electronic circuitry, where cold cathode 404, extraction grid 406 and anode 408 are powered from a single end of device 302.

FIG. 8B shows an exploded view of a second exemplary end 850 of the cold cathode lighting device 302 of FIGS. 3 and 4 that is similar to, and located at an opposite end of tube 402 to the first exemplary end 800 of FIG. 8A. End unit 310B includes power converter 311B that is similar to power converter 311A and provides power to cold cathode 404, extraction grid 406 and anode 408 via connectors 852, 854 and 856, respectively. End unit 310B also provides mechanical support of cold cathode 404 and extraction grid 406, such that cold cathode 404 and extraction grid 406 are supported, preferably under tension, between end units 310A and 310B. In another embodiment, power converter 311B connects directly to one or both of cold cathode 404 and extraction grid 406, wherein ends of cold cathode 404 and extraction grid 406 are potted within dielectric material 811 of end unit 310B.

FIG. 8C shows an exploded view of an alternate second exemplary end 870 of the cold cathode lighting device 302 of FIGS. 3 and 4 that includes mechanical support 874, 876 for cold cathode 404 and extraction grid 406, respectively. In this embodiment, end unit 310B does not include second power converter 311B, but still provides mechanical support of cold cathode 404 and extraction grid 406 via supports 872 and 874, or directly by potting ends of cold cathode 404 and extraction grid 406 within dielectric material 811.

FIG. 8D shows an exploded view of an alternate second exemplary end 880 of the cold cathode lighting device 302 of FIGS. 3 and 4 illustrating the use of springs 882, 884 to provide mechanical tension and support of cold cathode 404 and extraction grid 406, respectively. As shown in FIG. 8D, springs 882 and 884 may be partially potted, or otherwise secured to, potting material 811 of end unit 310B. Although conical springs 882, 884 are shown, other types of spring may be used for tensioning and supporting cold cathode 404 and extraction grid 406 without departing from the scope hereof.

In the example of FIG. 8D, spring 882 provides tension and support of cold cathode 404, and springs 884 provide tension and support of extraction grid 406 via a circular disc 886. Springs 884 may also attached directly to extraction grid 406 and circular disc 886 may be omitted.

One or both of ends 800 and 850 (or end 870 if used in place of end 850) may include springs 882, 884 to apply tension to cold cathode 402 and/or extraction grid 404 when device 302 is assembled. Once assembled, device 302 exhibits a similar form factor to fluorescent tubes of the prior art, thereby enabling device 302 to replace such fluorescent tubes within existing lighting units.

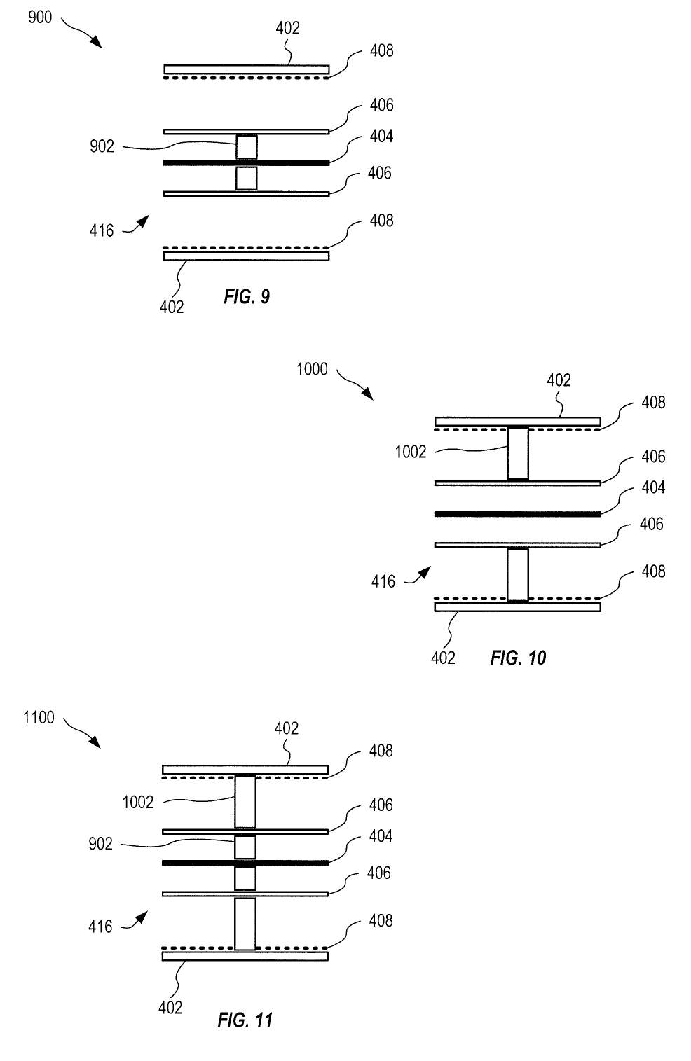

FIG. 9 shows a first exemplary structure 900 for maintaining spacing between cold cathode 404 and extraction grid 406 over the length of device 302 when using in mechanically harsh environments (e.g., vibration or altering G-forces). An electrically insulating spacer 902 (e.g., made from a dielectric material) is formed as a circular disc having a diameter substantially equal to the inside diameter of extraction grid 406, and a center hole that had a diameter substantially equal to the diameter of cold cathode 404. One or more spacers 902 may be positioned onto cold cathode 404 and within extraction grid 406 to prevent unwanted variation in distance (e.g., distance R, FIG. 5) between cold cathode 404 and extraction grid 406 over the length of device 302.

FIG. 10 shows one exemplary structure 1000 illustrating the use of a spacer 1002 formed as a circular disc having a diameter substantially equal to the internal diameter of tube 402 with a central hole of a diameter substantially equal to an external diameter of extraction grid 406. One or more spacers 1002 are positioned over extraction grid 406 and within tube 402 such that extraction grid 406 is maintained equidistant from anode 408 over the length of device 302. FIG. 11 shows one exemplary structure 1100 illustrating use of both spacer 902 of FIG. 9 and spacer 1002 of FIG. 10 to maintain position of cold cathode 404 and extraction grid 406 within tube 402.

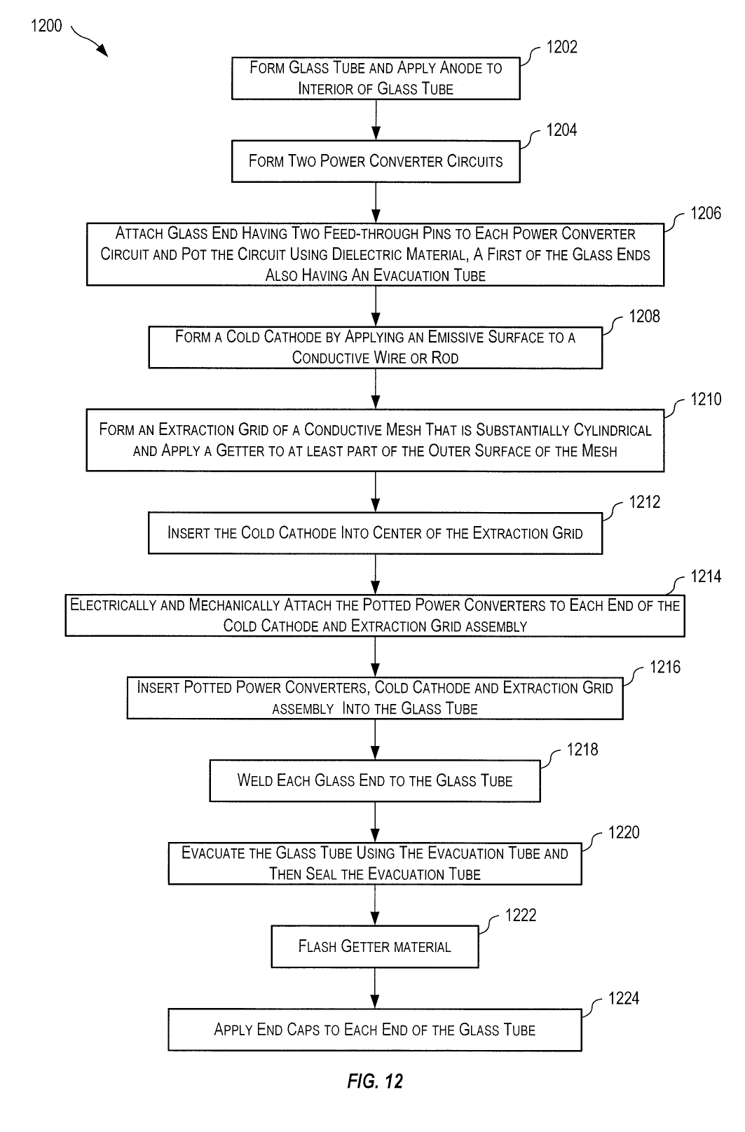

FIG. 12 is a flowchart illustrating one exemplary process 1200 for constructing cold cathode lighting device 302 of FIGS. 3 and 4. In step 1202, process 1200 forms the transparent tube and applies the anode to the interior of the transparent tube. In one example of step 1202, transparent tube 402 is formed using processes known in the art, and anode 408 is deposited onto the inside of transparent tube 402 by a by one or more of spray, slurry, settlement and EPD. In step 1204, process 1200 forms two power converter circuits. In one example of step 1204, circuit boards 822 are populated with components 824 to form power converter circuit 311A and 311B. In step 1206, process 1200 attaches a tube end that has two feed-through pins to each power converter circuit and pots each circuit using a dielectric material. One of the tube ends also has an evacuation tube. In one example of step 1206, tube end 826, FIG. 8A, with feed-through pins 414A and evacuation tube 828 is connected to power converter circuit 311A and converter circuit 311A is potted in dielectric material 811 to form end unit 310A. Tube end 858, FIG. 6B is attached to converter circuit 311B via pins 414B and converter circuit 311B is potted in dielectric material 811 to form end unit 310B.

In step 1208, process 1200 forms a cold cathode by applying an emissive surface to a conductive wire or rod. In one example of step 1208, a carbon deposit is formed on the surface of an aluminum wire. In another example, an outer surface of a copper tube is etched to form an emissive surface, for example to increase surface area.

In step 1210, process 1200 forms an extraction grid of a conductive mesh that is substantially cylindrical and applies a getter material to outer surface of mesh. In one example of step 1210, a fiberglass mesh tube is coated with a conductive material to form extraction grid 406 and getter material 407 is applied to at least part of an outer surface of extraction grid 406. In another example of step 1210, a plurality of conductive wires 606 and helically wrapped wire 706 form extraction grid 406 and getter material 407 is applied to at least part of wire 606 and/or wire 706.

In step 1212, process 1200 inserts the cold cathode into center of the extraction grid. In one example of step 1212, cold cathode 404 is inserted into extraction grid 406. In another example of step 1212, one or more spacers 902, FIG. 9, are inserted onto cold cathode 404 and then cold cathode 404 and spacers 902 are inserted into extraction grid 406.

In step 1214, process 1200 electrically and mechanically attaches the potted power converters to each end of the cold cathode and extraction grid assembly. In one example of step 1214, connectors 832 and 834 (FIG. 8A) of potted converter circuit 311A connect to one end of the assembled cold cathode 404 and extraction grid 406, respectively, and connectors 852 and 854 (FIG. 8B) of potted converter circuit 311B connect to the other ends of the assembled cold cathode 404 and extraction grid 406, respectively. In another example of step 1214, at least one end unit 310 includes one or more springs 884, 882 (FIG. 8D) that attach to cold cathode 404 and extraction grid 406 to provide mechanical support and optionally electrical connectivity.

In step 1216, process 1200 inserts the potted power converters, cold cathode and extraction grid assembly into the transparent tube of step 1202. In one example of step 1216, the end units 310, cold cathode 404 and extraction grid 406 assembly is inserted into tube 402.

In step 1218, process 1200 welds each tube end to the transparent tube. In one example of step 1218, tube ends 826 and 858 are welded to transparent tube 402 using techniques known in the art.

In step 1220, process 1200 evacuates the transparent tube using the evacuation tube and then seals the evacuation tube. In one example of step 1220, a vacuum is formed within tube 402 by extracting air from evacuation tube 828, and then evacuation tube 828 is sealed by heating and pinching glass of evacuation tube 828.

In step 1222, process 1200 flashes the getter material. In one example of step 1222, electromagnetic energy is applied external to tube 402 to flash getter material 407.

In step 1224, process 1200 applies end caps to each end of the transparent tube. In one example of step 1224, end caps 412A and 412B are applied to opposite ends of tube 402 and filled with a dielectric material.

Ordering of steps of process 1200 may vary without departing from the scope hereof.

In one example of operation, each power converter 311 receives power from power supply 304, optionally via dimmer unit 306, and generates electrical potentials for each of cold cathode 404, extraction grid 406 and anode 408. The potential of extraction grid 406 is greater than the potential of cold cathode 404 and electrons are emitted from cold cathode 404 towards extraction grid 406. The potential of anode 408 is higher than the potential of extraction grid 406 and the electrons are accelerated towards the anode from the extraction grid. The electrons impact the anode and excite the phosphor of the anode such that light is emitted from the lighting device 302. Where dimmer unit 306 is included, each power converter 311 varies the potential of extraction grid 406 relative to cold cathode 404 in response to dimmer unit 306, thereby varying the amount of light emitted from device 302. Power converter 311 may analyze the waveform of electrical power entering pins 414 from dimmer unit 306 to determine a setting of dimmer unit 306, and adjust the voltage of extraction grid 406 accordingly.

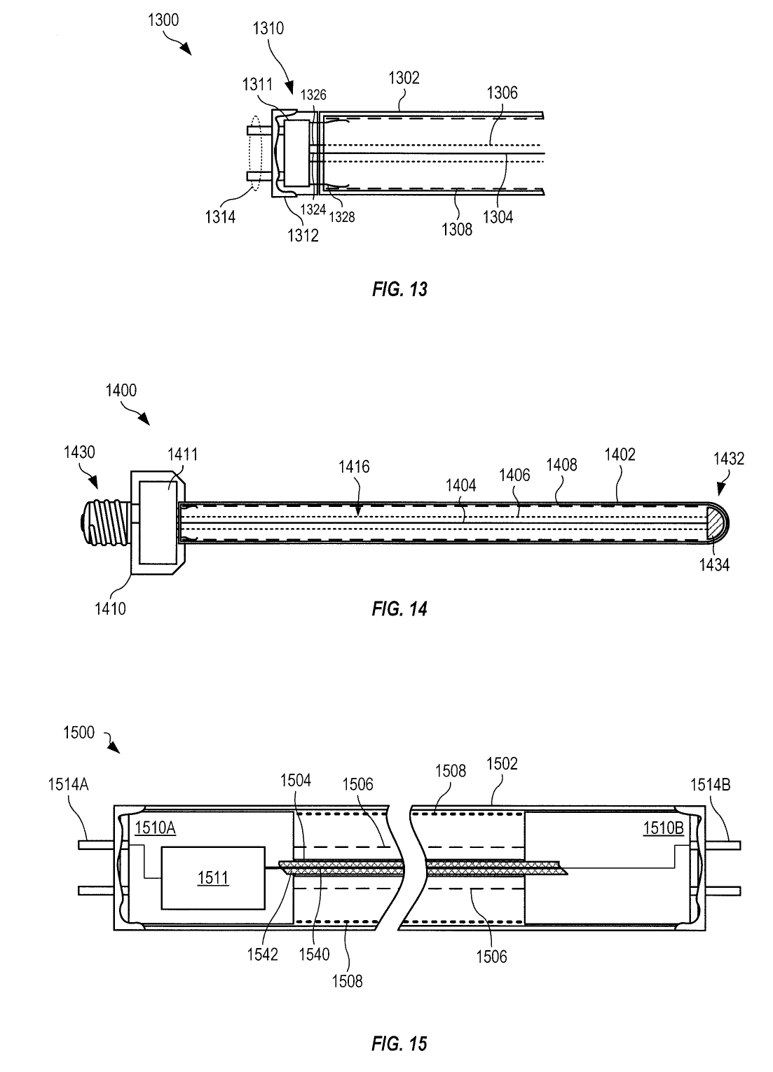

FIG. 13 shows one end of a cold cathode light emitting device 1300 similar to device 302 of FIGS. 3 and 4, but with an end unit 1310 positioned external to transparent tube 1302, in an alternate embodiment. Device 1300 includes a cold cathode 1304, an extraction grid 1306 and an anode layer 1308 that are substantially similar to cold cathode 404, extraction grid 406 and anode layer 408 of device 302, FIG. 4. Electrical connectors 1324, 1326 and 1328 pass through an end of transparent tube 1302 to provide connectivity to cold cathode 1304, extraction grid 1306 and anode layer 1308 from electronics within a power converter unit 1311, respectively. Connectors 1324, 1326 and 1328 may each have one or more electrical conductors that pass through the end of transparent tube 1302. Power converter unit 1311 has two external pins 1314 that connect to an external source of electrical power. Pins 1314 are similar to pins 414 of device 302. Converter unit 1311 connects to connectors 1324, 1326 and 1328 and is then potted within a dielectric material for form end unit 1310. An end cap 1312 may be applied to the end of device 1302.

FIG. 14 shows one exemplary cold cathode lighting device 1400 configured with an Edison thread attachment that allows device 1400 to be used within a conventional Edison screw lighting fixture. Device 1400 has a cold cathode 1404, an extraction grid 1406, and an anode layer 1408, formed within a transparent tube 1402. Cold cathode 1404, extraction grid 1406 and anode layer 1408 are similar to cold cathode 404, extraction grid 406 and anode layer 408 of device 302. A power converter unit 1411 is formed external to tube 1402 and potted within a dielectric material to form an end unit 1410. Power converter unit 1411 is similar to converter unit 311 of device 302. However, end unit 1410 has an Edison thread that couples, electrically and mechanically, with a threaded socket of a conventional lighting fixture, and provides power and support for device 1400. A free end 1432 of device 1400 is shown rounded, but may be otherwise shaped without departing from the scope hereof. Within transparent tube 1402, at end 1432, a mechanical support 1434 may be included to support cold cathode 1404 and extraction grid 1406. Alternatively, spacers, similar to spacers 902 and 1002 of FIGS. 9 and 10, may be included within tube 1402 to support cold cathode 1404 and extraction grid 1406.

Within an unmodified prior art fluorescent lighting fixture, neutral of the supplied power typically connects to a first end of the fixture, and the live of the supplied power connects, serially with the ballast, to the other end of the fixture. Typically, the ballast operates to both step up the received voltage and limit the current through the fluorescent tube such that the tube operates at the specified power (e.g., 40 watts).

FIG. 15 shows one exemplary cold cathode lighting device 1500 configured to operate within an unmodified fluorescent tube lighting fixture (e.g., fixture 100, FIG. 1), where cold cathode lighting device 1500 replaces the conventional fluorescent tube (e.g., fluorescent tube 102). Cold cathode lighting device 1500 includes a cold cathode 1504, an extraction grid 1506 and an anode layer 1508 within a transparent tube 1502. A power converter 1511 is potted within one end unit 1510A and electrically connected to a first pin 1514A. Electrical connectivity between power converter 1511 and cold cathode 1504, extraction grid 1506 and anode layer 1508 are not shown for clarity.

Cold cathode 1504 is formed as a cylindrical tube such that an additional electrical connection 1540 sheathed in an insulating material 1540 may pass therethrough without affecting operation of cold cathode 1504. Connection 1540 connects power converter 1511 to a pin 1514B at the other end of device 1500.

Since efficiency of cold cathode lighting devices 1500 is greater than that of the conventional fluorescent tube, when cold cathode lighting device 1500 is installed within a conventional fluorescent lamp fixture, power converter 1511 receives sufficient power through the ballast of the fixture for normal operation. Any conventional fluorescent tube starter in the fixture is not in circuit and may optionally be removed from the fixture.

Power converter 1511 converts power, received through the ballast if it remains in circuit, to provide potentials to cold cathode 1504, extraction grid 1506 and anode layer 1508 such that device 1500 operates in a manner similar to device 302 of FIG. 4. However, it should be noted that if the ballast of the fixture remains in circuit, the power factor of the load may not be optimal.

In one example of operation, power converter 311 receives power from power supply 304, optionally via dimmer unit 306, and generates electrical potentials for each of cold cathode 1504, extraction grid 1506 and anode 408. The potential of extraction grid 1506 is greater than the potential of cold cathode 1504 and electrons are emitted from cold cathode 1504 towards extraction grid 1506. The potential of anode 408 is higher than the potential of extraction grid 1506 and the electrons are accelerated towards the anode from the extraction grid. The electrons impact the anode and excite the phosphor of the anode such that light is emitted from the lighting device 302. Where dimmer unit 306 is included, power converter 311 varies the potential of extraction grid 1506 relative to cold cathode 1504 in response to dimmer unit 306, thereby varying the amount of light emitted from device 302. Power converter 311 may analyze the waveform of electrical power entering pins 414 from dimmer unit 306 to determine a setting of dimmer unit 306, and adjust the voltage of extraction grid 1506 accordingly.

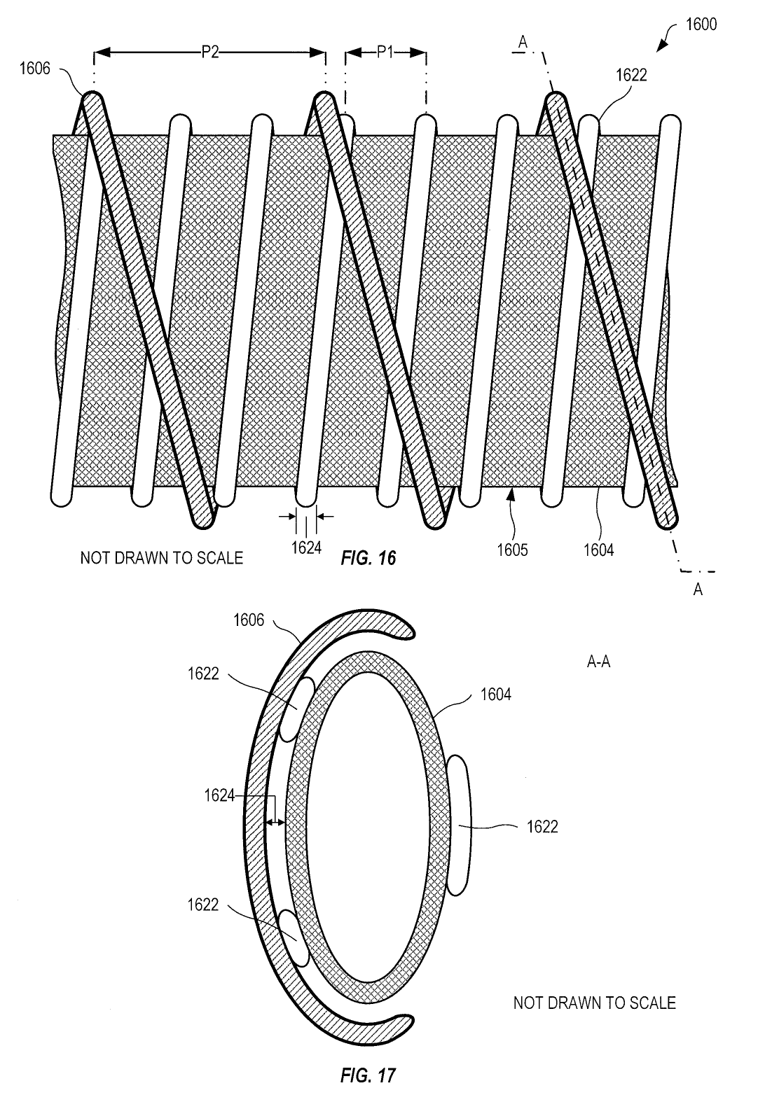

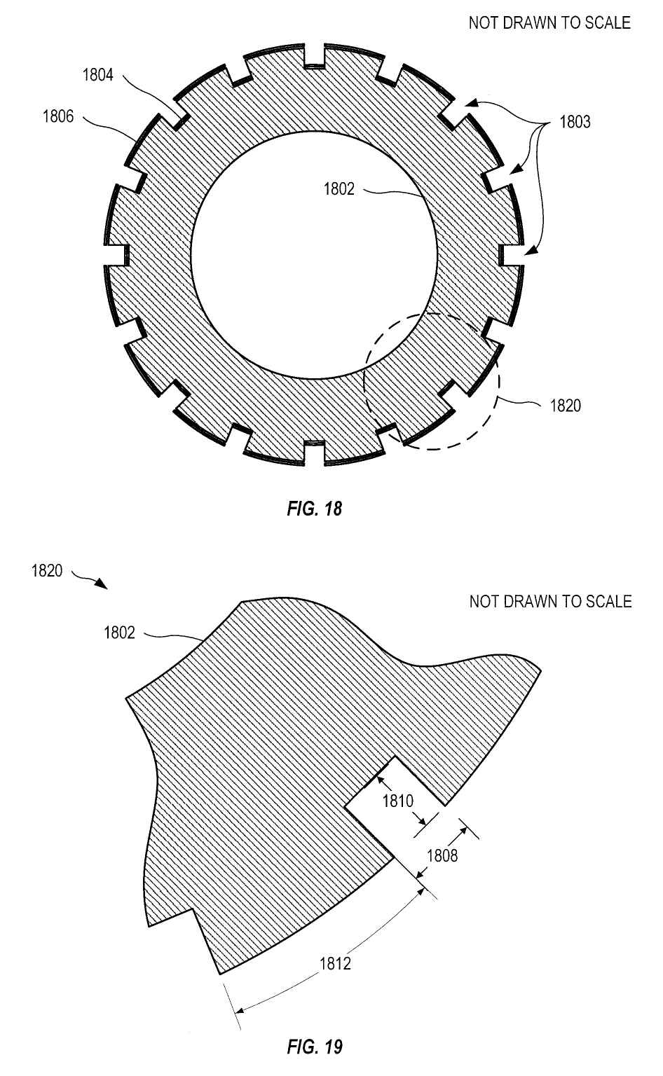

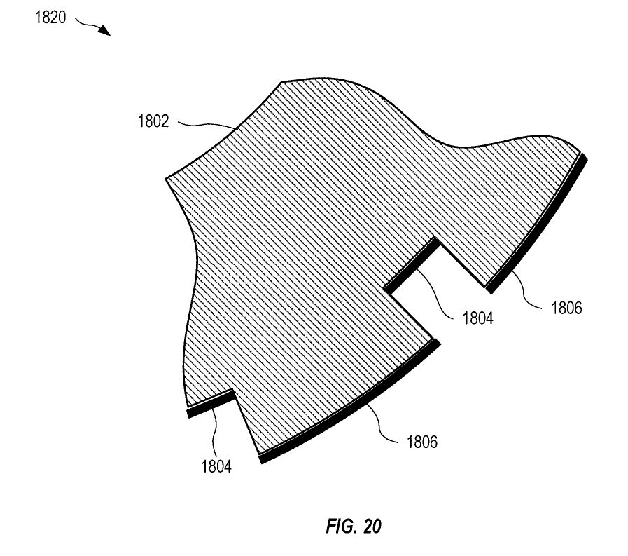

FIG. 16 shows a portion of an exemplary cold cathode and extractor grid assembly 1600 that includes a cold cathode 1604 and a conducting fiber 1606 for use in cold cathode lighting device 302 of FIG. 3. FIG. 17 shows a cross section through plane A-A of the cold cathode and extractor assembly 1600 of FIG. 16. FIGS. 16 and 17 are best viewed together with the following description.

The distance between cold cathode 1604 and conducting fiber 1606 determines the voltage potential required therebetween to extract electrons from the cold cathode. As this distance increases, the voltage potential required increases exponentially. Thus, the tolerance in variation of this distance should be small.

Cold cathode 1604 may be fabricated as a wire, rod or tube with an electron emissive outer surface 1605. In an embodiment, cold cathode 1604 has tubular construction to reduce weight while maintaining strength such that cold cathode 1604 is substantially self supporting over the length of the cold cathode lighting device when attached at one or both ends. A spacing fiber 1622 is wound around cold cathode 1604 in a first direction at a pitch P1 for the operational (electron emitting) length of cold cathode 1604. Spacing fiber 1622 is an insulator with a substantially uniform diameter that is selected to provide gap 1624 between emissive surface 1605 and extractor conductor 1606. Spacing fiber 1622 is a glass or plastic strand for example, such as a fiber optic. A conducting fiber 1606 is wound around cold cathode 1604 and spacing fiber 1622 in the opposite direction from the first direction and at a pitch P2 that is greater than pitch P1, such that conducting fiber 1606 is spaced a distance substantially equal to width 1624 from the emitting surface of cold cathode 1604. Conducting fiber 1606 is for example a fiber optic strand coated with a conductor, such as aluminum or other electrically conducting material.

The use of spacer fiber 1622 may provide a cheaper and more controlled manufacturing solution as compared to other embodiments. Pitch P1 is selected to provide sufficient support for conducting fiber 1606 while leaving sufficient area of cold cathode 1604 operable for electron emission. The diameter of conducting fiber 1606 and its resistance to flex help maintain its distance 1624 from emissive surface 1605 between windings of spacer fiber 1622. If conducting fiber 1606 has a low flex resistance (i.e., conducting fiber 1606 is less self supporting), pitch P1 of spacing fiber 1604 may reduced to maintain distance 1624.

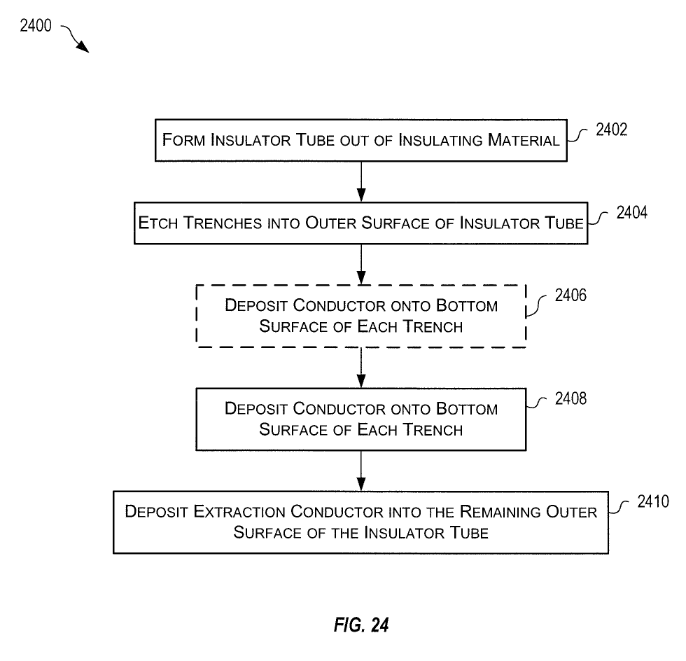

FIG. 18 is a cross section showing an alternate construction for a cold cathode emissive surface 1804 and an extraction conductor 1806 formed on an insulator tube 1802 and for use in a cold cathode lighting device. FIG. 19 is a cross section showing a portion 1820 of insulator tube 1802 of FIG. 18 in greater detail. FIG. 20 is a cross section showing portion 1820 of the insulator tube of FIG. 18 with the addition of cold cathode emissive surface 1804 and extraction conductor 1806 of FIG. 18. FIG. 24 is a flowchart illustrating one exemplary method 2400 for manufacturing the cold cathode and extractor assembly 1800 of FIGS. 18, 19 and 20. FIGS. 18, 19, 20 and 24 are best viewed together with the following description.

Insulator tube 1802 is formed, step 2402, out of an insulating material, such as glass, ceramic, with an outside diameter in the range of between 5 and 500 mm. Several trenches 1803 are formed, for example by extrusion, etching as in step 2404, lengthwise on the external surface of insulator tube 1802, each having a width 1808 and a depth 1810 and a spacing of 1812. With 1808 has a range of between 1 and 5 mm, and depth 1810 has a range of between 0.5 and 2 mm. Optionally, a cold cathode conductor (not shown) is deposited, step 2406, within each trench 1803, upon which to form cold cathode emissive surface 1804. Cold cathode emissive surface 1804 is deposited, step 2408, within each trench 1803 (optionally onto the cold cathode conductor of step 2406 if included). Extraction conductor 1806 is deposited, step 2410, onto the remaining outer surface of insulator tube 1802.

The etching and deposition processes of method 2400 may be similar to those known in the semiconductor fabrication industry. The order of these processes (steps) may be changed without departing from the scope hereof. For example, extraction conductor 1806 may be deposited onto the outer surface of insulator tube 1802 prior to etching to form trenches 1803 and/or deposition of cold cathode emissive surface 1804.

Although substantially square trench cross-sections are shown in the example of FIGS. 18, 19 and 20, trenches 1803 may be formed with other cross-sectional shapes such that an electric field formed between extraction conductor 1806 and cold cathode emissive surface such that electrons are emitted from cold cathode emissive surface 1804. Trenches can have a cross-sectional shape selected from the group of shapes including: rectangular, trapezoidal with wide top and narrow bottom, trapezoidal with narrow top and wide bottom.

In an alternate embodiment, insulator tube 1802 is a solid rod of insulating material. In yet another embodiment, insulator tube 1802 is a conductive tube, or rod, upon which a coating of insulating material is deposited and then etched, scored, or ground to reveal the conductive surface. Extractor conductor 1806 is then deposited onto the coating of insulating material.

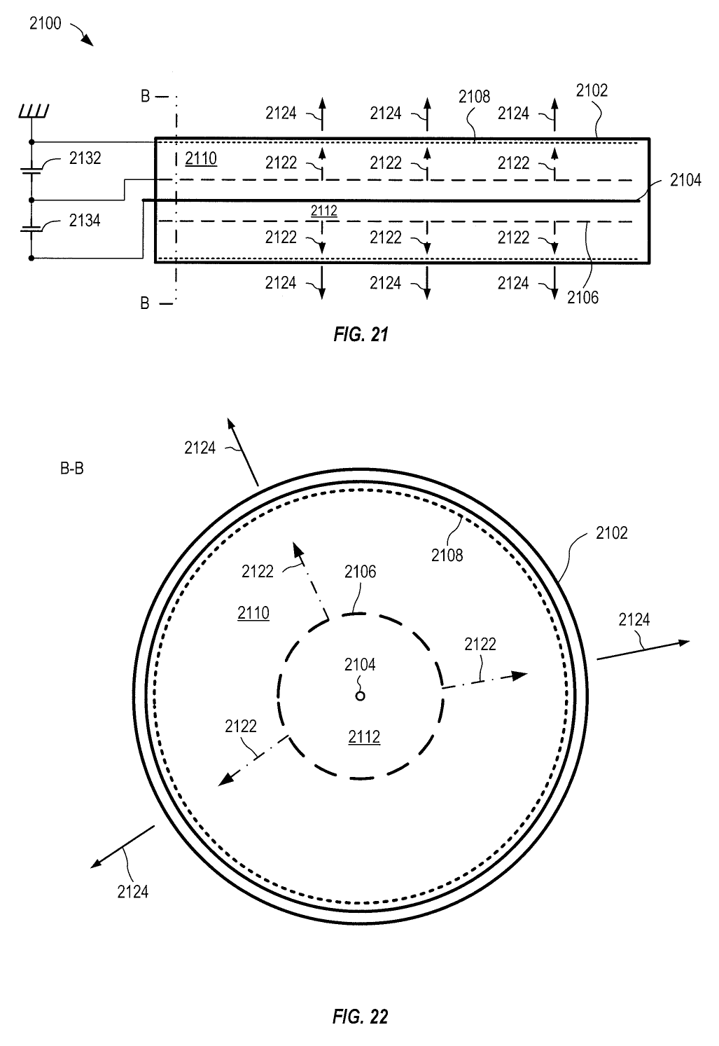

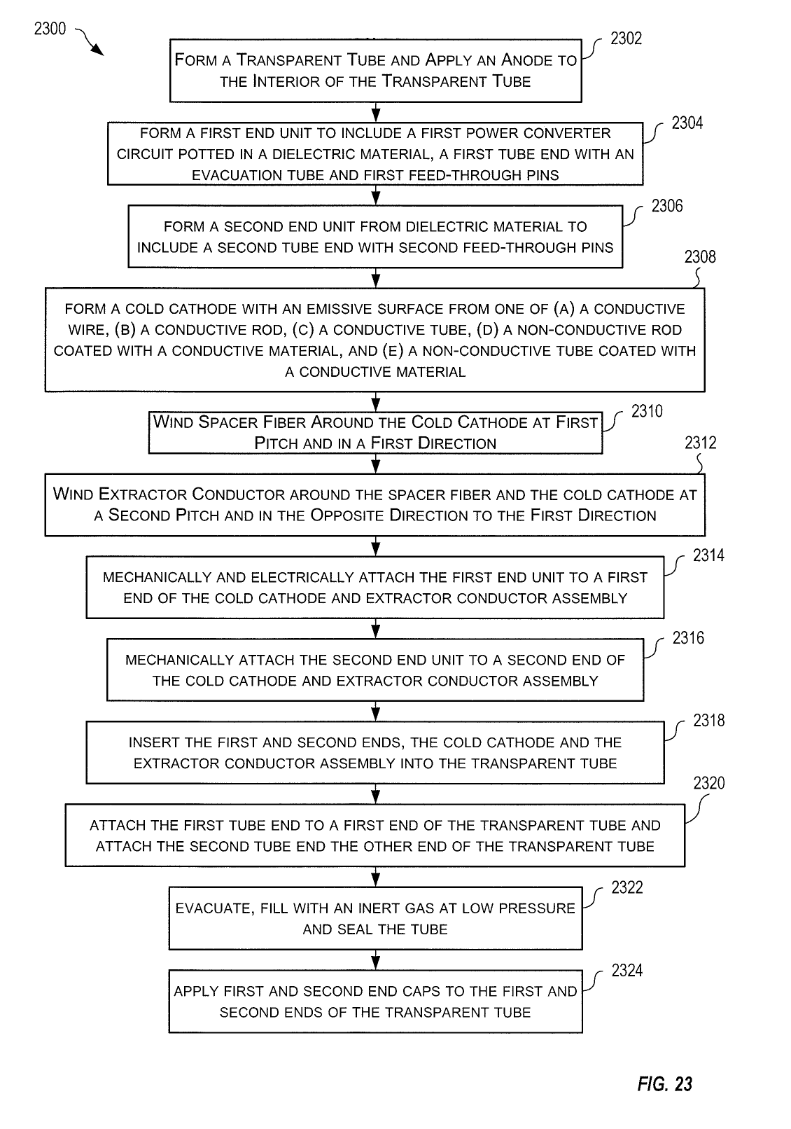

FIG. 21 shows a portion of an exemplary lamp 2100 constructed as a replacement to a conventional fluorescent tube and based upon a contained plasma electron emitter. FIG. 22 is a cross section B-B through lamp 2100 of FIG. 21. FIGS. 21 and 22 are best viewed together with the following description.

Lamp 2100 has a transparent tube 2102 with an internal coating that forms an anode 2108. Tube 2102 is for example glass, or other similar material. Anode 2108 is for example formed of a phosphor layer and an electrically conductive layer. A conductive wire 2104 passes lengthwise through the center of tube 2102 and is surrounded by a tubular mesh 2106 that is positioned equidistant from wire 2104. Transparent tube 2102 is closed at each end and electrical connection s pass through at lease one end to provide electrical connectivity to wire 2104, mesh 2106 and anode 2108. Tube 2102 is filled with a low pressure, in the range of between 10 and 1000 mTorr, gas, such as a noble gas (e.g., neon, argon, xenon), or mix thereof, and other non-reactive gasses. In an embodiment, a distance between mesh 2106 and anode 2108 is in the range of between 3 mm and 10 mm; a distance between wire 2104 and mesh 2106 is in the range of between 0.5 cm and 5 cm; and the diameter of wire 2104 is in the range between 0.04 mm and 0.5 mm.

In one example of operation, anode 2108 is held substantially at ground potential and a potential of 10 kV, illustratively represented by a battery 2132, is applied between anode 2108 and mesh 2106 such that mesh 2106 is negative with respect to anode 2108. A second potential of between 100V and 1000V, illustratively represented by a battery 2134, is applied between mesh 2106 and wire 2104 such that wire 2104 is more positive than mesh 2106, but still negative with respect to anode 2108. The voltage between mesh 2106 and wire 2104 generates a plasma within a gap 2112 between mesh 2106 and wire 2104. Since plasma has negative resistivity, current through the plasma is limited, for example by a ballast or other such electronic circuitry. An alpha and/or beta emitter may be included within gap 2112 to facilitate ignition of the plasma.

Paschen's law, as known in the art, may be used to predict the voltage at which plasma will form for a given the type of gas, at a given gas pressure and for a given distance between electrodes (e.g., mesh 2106 and wire 2104). Within lamp 2100, mesh 2106 is in substantially closer proximity to wire 2104 than to anode 2108, such that plasma forms in gap 2112 between wire 2104 and mesh 2106, but does not form in a gap 2110 between mesh 2106 and anode 2108.

Some free electrons within the plasma pass through mesh 2106 and are accelerated, by the electrical field between anode 2108 and mesh 2106, towards anode 2108 (and the phosphor layer) such that light is generated by the phosphor and output from the device.

A current of 10 mA for example flows between wire 2104 and mesh 2106 when plasma is formed, thereby requiring approximately 1 W of power. In the same embodiment, current flowing between mesh 2106 and anode 2108 is 1 mA for example, thereby requiring 10 W of power.

FIG. 23 shows one exemplary method 2300 for fabricating a cold cathode fluorescent tube replacement lighting device utilizing the cold cathode and extractor conductor of FIGS. 16 and 17 in a device similar to cold cathode lighting device 302 of FIGS. 3 and 4.

In step 2302, method 2300 forms a transparent tube and applies an anode to the interior of the transparent tube. In one example of step 2302, transparent tube 402 is formed and anode 408 is applied to the inner surface of tube 402. In step 2304, method 2300 forms a first end unit to include a first power converter circuit potted in a dielectric material, a first tube end with an evacuation tube and first feed-through pins. In one example of step 2304, power converter 311A potted in dielectric material 811, first tube end 826 with evacuation tube 828, and feed through pins 414A, are combined to form end unit 310A.

In step 2306, method 2300 forms a second end unit from dielectric material to include a second tube end with second feed-through pins. In one example of step 2306, tube end 858 and pins 414B are combined and pins 414B re potted in dielectric material 811 to form end unit 310B. In step 2308, method 2300 forms a cold cathode with an emissive surface from one of (a) a conductive wire, (b) a conductive rod, (c) a conductive tube, (d) a non-conductive rod coated with a conductive material, and (e) a non-conductive tube coated with a conductive material. In one example of step 2308, cold cathode 1604 is formed as a conductive tube with electron emissive surface 1605.

In step 2310, method 2300 winds a spacer fiber around the cold cathode at a first pitch and in a first direction. In one example of step 2310, spacer fiber 1622 is wound around cold cathode 1604 at pitch P1 in a first direction. In step 2312, method 2300 winds an extractor conductor around the spacer fiber and the cold cathode at a second pitch and in the opposite direction to the first direction. In one example of step 2312, extractor conductor 1606 is wound around cold cathode 1604 and spacer fiber 1622 at pitch P2 and in an opposite direction to the winding of spacer fiber 1622.

In step 2314, method 2300 mechanically and electrically attaches the first end unit to a first end of the cold cathode and extractor conductor assembly. In one example of step 2314, end unit 310A is mechanically and electrically attached to a first end of cold cathode 1604 and a first end of extractor conductor 1606. In step 2316, method 2300 mechanically attaches the second end unit to a second end of the cold cathode and extractor conductor assembly. In one example of step 2316, end unit 310B is mechanically attached to the other end of cold cathode 1604.

In step 2318, method 2300 inserts the first and second ends and the cold cathode and the extractor conductor assembly into the transparent tube. In one example of step 2318, end units 310A, 310B, cold cathode 1604, spacer fiber 1622 and extractor conductor 1606 are inserted into transparent tube 402.

In step 2320, method 2300 attaches the first tube end to a first end of the transparent tube and attaches the second tube end the other end of the transparent tube. In one example of step 2320, tube ends 826 and 858 are welded to transparent tube 402 using techniques known in the art. In step 2322, method 2300 evacuates, fills with an inert gas at low pressure, and seals the transparent tube. In one example of step 2322, a vacuum is formed within tube 402 by extracting air from evacuation tube 828, an inert gas, such as Nitrogen (or other suitable gas such as a noble gas, or mixture thereof) is then introduced through evacuation tube 828 such that tube 402 is filled with Nitrogen (or other suitable gas) at a low pressure (e.g., between 10 and 1000 mTorr) and then evacuation tube 828 is sealed by heating and pinching glass of evacuation tube 828.

In step 2324, method 2300 applies first and second end caps to the first and second ends of the transparent tube. In one example of step 2324, end caps 412A and 412B are applied to opposite ends of tube 402 and filled with a dielectric material.

Ordering of steps of method 2300 may vary without departing from the scope hereof.

Phosphor material for use in phosphor layers of anodes 408, 1308, 1408, 1508 and 2108 of FIGS. 4, 13, 14, 15 and 21, respectively, may be selected based upon a desired output spectrum. For example, where the light emitting device is used for growing plants, phosphor materials may be selected such that the light emitting device outputs a light spectrum substantially similar to natural daylight.

Changes may be made in the above methods and systems without departing from the scope hereof. For example, to reduce weight of device 302, cold cathode 404 and/or extraction grid 406 may be constructed of one or more non-conductive materials coated with a conductive material. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A cold cathode lighting device as fluorescent tube replacement, comprising:
a transparent tube;
a cold cathode formed as a wire or rod with an electron emissive surface and passing through a center of the transparent tube;
an extraction grid formed around and spaced apart from the cold cathode and having an external diameter smaller than an inner diameter of the transparent tube;
an anode formed on an inner surface of the transparent tube and comprising a phosphor material and a conductive material; and
a first end unit comprising a first power conversion circuit potted within a dielectric material, the first power conversion circuit having electrical connections to each of the cold cathode, the extraction grid and the anode;
wherein a vacuum is maintained within the transparent tube and the first power converter converts electrical power applied to the device into a first potential applied to the cold cathode, a second potential applied to the extraction grid and a third potential applied to the anode such that electrons emitted from the cold cathode are accelerated towards the anode and light is emitted from the fluorescent tube replacement light emitting device.

2. The device of claim 1, further comprising first electrical pins for providing electrical connectivity to the first power conversion circuit and mechanical support to the first end unit.

3. The device of claim 1, further comprising a second end unit formed of a dielectric material to provide mechanical support for the cold cathode and the extraction grid.

4. The device of claim 3, further comprising one or more springs for maintaining tension between the second end and one or both of (a) the cold cathode and (b) the extraction grid.

5. The device of claim 3, further comprising second electrical pins for providing mechanical support to the second end unit.

6. The device of claim 3, the second end unit further comprising a second power conversion circuit for converting electrical power applied to the second electrical feed-through pins into the first potential applied to the cold cathode, the second potential applied to the extraction grid and the third potential applied to the anode.

7. The device of claim 3, wherein the second end unit is positioned within a second end of the transparent tube.

8. The device of claim 3, wherein the second end unit is positioned external to the transparent tube.

9. The device of claim 1, wherein the first end unit is positioned within a first end of the transparent tube.

10. The device of claim 1, wherein the first end unit is positioned external to the transparent tube.

11. The device of claim 1, wherein the cold cathode is formed as a tube, the device further comprising a conductive wire running through the center of the cold cathode and insulated from the cold cathode by an electrically insulating material, the conductive wire conducting power from a first end of the device to a second end of the device.

12. The device of claim 1, wherein the device is operable within an unmodified conventional fluorescent light fixture.

13. The device of claim 1, the first end further comprising a surface having an Edison thread to connect the device to an Edison socket of a lighting fixture, the Edison thread receiving mechanical support for the device from the fixture.

14. The device of claim 1, further comprising one or more spacers positioned between the cold cathode and the extraction grid for maintaining the distance between the cold cathode and the extraction grid, the spaced being formed of an insulator type material.

15. The device of claim 1, further comprising one or more spacers positioned between the extraction grid and the anode layer for maintaining the distance between the extraction grid and the anode layer, the spaced being formed of an insulator type material.

16. The device of claim 1, further comprising a getter material formed on the outer surface of the extraction grid, the getter material being flashed by external application of electromagnetic energy.

17. The device of claim 1, further comprising a getter material formed on at least part of the anode, the getter material being flashed by external application of electromagnetic energy.

18. The device of claim 1, the extraction grid being formed of a metallic mesh material formed into a cylinder.

19. The device of claim 1, the extraction grid being formed of a plurality of components selected from the group consisting of wires and rods, the components being substantially symmetrically spaced around, and at a substantially constant distance from, the cold cathode.

20. The device of claim 19, wherein the components are electrically conductive.

21. The device of claim 19, wherein the components are not electrically conductive, the device further comprising a conductive wire helically wound around the components.

22. A method for fabricating a light emitting device comprising the steps of:
forming a transparent tube and applying an anode to the interior of the transparent tube;
forming a first end unit to include a first power converter circuit potted in a dielectric material, a first tube end with an evacuation tube and first feed-through pins;
forming a second end unit from dielectric material to include a second tube end with second feed-through pins;
forming a cold cathode with an emissive surface from one of (a) a conductive wire, (b) a conductive rod, (c) a conductive tube, (d) a non-conductive rod coated with a conductive material, and (e) a non-conductive tube coated with a conductive material;
forming a substantially cylindrical extraction grid having an internal diameter greater than the external diameter of the cold cathode;
inserting the cold cathode into the center of the extraction grid;
electrically and mechanically attaching the first end unit to a first end of the cold cathode and extraction grid assembly;
mechanically attaching the second end unit to a second end of the cold cathode and extraction grid assembly;
inserting the first and second end units, the cold cathode and the extraction grid assembly into the transparent tube;
attaching the first tube end to a first end of the transparent tube and attaching the second tube end the other end of the transparent tube;
evacuating and sealing the transparent tube; and
applying first and second end caps to the first and second ends of the transparent tube.

23. The method of claim 22, further comprising the steps of:
applying a getter to at least part of the outer surface of the extraction grid; and
flashing the getter material once the transparent tube is evacuated.

24. The method of claim 22, further comprising the steps of:
applying a getter to at least part of the anode; and
flashing the getter material once the transparent tube is evacuated.

25. The method of claim 22, the step of forming the second end unit comprising including a second power converter circuit.

26. A method for fabricating a light emitting device to replace a fluorescent tube, comprising the steps of:
forming a transparent tube and applying an anode to the interior of the transparent tube;
forming a first end unit to include a first tube end with an evacuation tube and first feed-through pins;
forming a second end unit from dielectric material to include a second tube end with second feed-through pins;
forming a cold cathode with an emissive surface from one of (a) a conductive wire, (b) a conductive rod, (c) a conductive tube, (d) a non-conductive rod coated with a conductive material, and (e) a non-conductive tube coated with a conductive material;
forming a substantially cylindrical extraction grid having an internal diameter greater than the external diameter of the cold cathode;
inserting the cold cathode into the center of the extraction grid;
mechanically and electrically attaching the first end unit to a first end of the cold cathode and extraction grid assembly;
mechanically attaching the second end unit to a second end of the cold cathode and extraction grid assembly;
inserting the first and second ends and the cold cathode and the extraction grid assembly into the transparent tube;
attaching the first tube end to a first end of the transparent tube and attaching the second tube end the other end of the transparent tube;
evacuating and sealing the transparent tube;
forming a first power converter circuit potted in a dielectric material and electrically connecting the first power converter circuit to the anode, cold cathode and extraction grid via the first feed through pins, the first power converter circuit having electrical pins to connect to a power source and to mechanically support the first power converter circuit and transparent tube; and
applying a first end cap to first power converter and applying a second end cap to the second end of the transparent tube.

27. The method of claim 26, further comprising the steps of:
applying a getter to at least part of the outer surface of the extraction grid; and
flashing the getter material once the transparent tube is evacuated.

28. The method of claim 26, further comprising the steps of:
applying a getter to at least part of the anode; and
flashing the getter material once the transparent tube is evacuated.

29. The method of claim 26, the step of forming the second end unit comprising including a second power converter circuit.

30. A cold cathode light emitting device, comprising:
a transparent tube;
a cold cathode having a substantially cylindrical electron emissive surface and passing through a center of the transparent tube;
a spacing fiber wound around the cold cathode at a first pitch and in a first direction;
a conducting fiber wound around the cold cathode and the spacing fiber at a second pitch and opposite to the first direction, such that the conducting fiber is spaced apart from the cold cathode by the spacing fiber;
an anode formed on an inner surface of the transparent tube and comprising a phosphor material and a conductive material; and
a first end unit comprising a first power conversion circuit potted within a dielectric material, the first power conversion circuit having electrical connections to each of the cold cathode, the conducting fiber and the anode;
wherein a vacuum is maintained within the transparent tube and the first power converter converts electrical power applied to the device into a first potential applied to the cold cathode, a second potential applied to the conducting fiber and a third potential applied to the anode such that electrons emitted from the cold cathode are accelerated towards the anode and light is emitted from the fluorescent tube replacement light emitting device.

31. The cold cathode light emitting device of claim 30, wherein the second pitch is greater than the first pitch.

32. The cold cathode light emitting device of claim 30, wherein the spacing fiber has a substantially uniform diameter equivalent to a required spacing between the cold cathode and the conducting fiber.

33. A method for fabricating a light emitting device to replace a fluorescent tube, comprising the steps of:
forming a transparent tube and applying an anode to the interior of the transparent tube;
forming a first end unit to include a first power converter circuit potted in a dielectric material, a first tube end with an evacuation tube and first feed-through pins;
forming a second end unit from dielectric material to include a second tube end with second feed-through pins;
forming a cold cathode with an emissive surface from one of (a) a conductive wire, (b) a conductive rod, (c) a conductive tube, (d) a non-conductive rod coated with a conductive material, and (e) a non-conductive tube coated with a conductive material;
winding a spacer fiber around the cold cathode at a first pitch and in a first direction;
winding an conducting fiber around the spacer fiber and the cold cathode at a second pitch and in the opposite direction to the first direction to form a cold cathode and extractor assembly;
mechanically and electrically attaching the first end unit to a first end of the cold cathode and extractor assembly;
mechanically attaching the second end unit to a second end of the cold cathode and conducting fiber assembly;
inserting the first and second ends, the cold cathode and the conducting fiber assembly into the transparent tube;
attaching the first tube end to a first end of the transparent tube and attaching the second tube end the other end of the transparent tube;
evacuating, filling with an inert gas at low pressure and sealing the transparent tube;
applying first and second end caps to the first and second ends of the transparent tube.

34. A cold cathode light emitting device, comprising:
a transparent tube;
an insulator tube passing through a center of the transparent tube and having a plurality of trenches formed lengthwise on the outer surface of the tube and having an emissive conductive material formed at the bottom of each of the trenches, and a extractor conductor formed on the outer surface of the tube between the trenches;
an anode formed on an inner surface of the transparent tube and comprising a phosphor material and a conductive material; and
a first end unit comprising a first power conversion circuit potted within a dielectric material, the first power conversion circuit having electrical connections to each of the emissive conductive material, the extractor conductor and the anode;
wherein a vacuum is maintained within the transparent tube and the first power converter converts electrical power applied to the device into a first potential applied to the emissive conductor, a second potential applied to the extractor conductor and a third potential applied to the anode such that electrons emitted from the emissive conductor are accelerated towards the anode and light is emitted from the fluorescent tube replacement light emitting device.

35. The cold cathode light emitting device of claim 34, the depth of each of the trenches being substantially constant such that the separation between the emissive conductive material and the extractor conductor extracts electrons substantially uniformly from the emissive conductor when the first and second potentials are applied.

36. A light emitting device, comprising:
a transparent tube;
a first anode passing through the center of the transparent tube;
a cylindrical mesh passing through the center of the transparent tube and surrounding the first anode;
a second anode formed on an inner surface of the transparent tube and comprising a phosphor material and a conductive material; and
a first end unit comprising a first power conversion circuit potted within a dielectric material, the first power conversion circuit having electrical connections to each of the emissive conductive material, the extractor conductor and the anode;
wherein a gas at a low pressure is maintained within the transparent tube and the first power converter converts electrical power applied to the device into a first potential applied to the first anode, a second potential applied to the cylindrical mesh, and a third potential applied to the second anode such that plasma is formed in a first gap between the first anode and the cylindrical mesh but not in a second gap between the cylindrical mesh and the second anode, and free electrons of the plasma are emitted from the cylindrical mesh and accelerated towards the second anode such that light is emitted from the light emitting device.
